(19) United States
(12) Patent Application Publication
(10) Pub. No.: US 2011/0227326 A1
(43) Pub. Date: Sep. 22, 2011

(54) CARD PRINTING METHOD AND APPARATUS

(76) Inventors: Tom Elgar, Oxford (GB); Adam Elgar, Stanford in the Vale (GB); Iain James Wishart Mcneill, London (GB); Andrew Christian Camargo Francis, London (GB)

(21) Appl. No.: 13/003,454

(22) PCT Filed: Jul. 10, 2009
(86) PCT No.: PCT/GB09/01715

§ 371 Date: May 19, 2011

Related U.S. Application Data
(60) Provisional application No. 61/121,886, filed on Dec. 11, 2008.
(60) Provisional application No. 61/079,795, filed on Jul. 10, 2008.

(51) Int. Cl. B42D 15/00; B07C 5/00

(52) U.S. Cl. 283/70; 209/552; 270/1.02

(57) ABSTRACT

A method of producing a plurality of transaction cards comprising the steps of providing a plurality of blank cards to which at least one element is to be applied, each card comprising at least one card tag, each card tag carrying production information identifying at least one element to be applied to the card and/or a location on the card at which at least one element is to be applied, wherein the production information carried by at least one of the plurality of card tags differs from the production information carried by at least another one of the plurality of card tags; reading the card tag; sorting the plurality of cards into at least first and second sorted groups based on the production information; and applying the at least one element to the card.

### FIELD OF THE INVENTION

This application relates to apparatus and methods for printing transaction cards, in particular printing personalised transaction cards.

### BACKGROUND

Recently there has been an increase in consumer desire for personalised cards, such as transaction cards, gift cards and telephone cards. International patent publication number WO 2006/018624, incorporated herein in its entirety, discloses an apparatus and method for personalising transaction cards.

FIG. 1 illustrates the main components of a transaction card 1. A transaction card comprises a base layer 109 sandwiched between two outer layers 107 upon which images 105 can be printed, and outer laminate layers 103.

As illustrated in FIGS. 2A and 2B, illustrating front surface 1A and back surface 1B of card 1, transaction cards typically also comprise elements such as the issuer's name and/or logo 201, the transaction card provider's name and/or logo 203, a computer chip 202 provided on front surface 1A and a magnetic readable strip 204, a user's signature strip 205 and a hologram 206 provided on back surface 1B. Other elements may be present and these elements can appear in any combination on either the front and/or the back surface of the transaction card.

Current transaction card printing apparatus is arranged to print large batches of transaction cards in one go, all the transaction cards in each batch having the same image and then for storing of these pre-printed transaction cards prior to application of individual users personal data, such as name and account number and the encoding of the chip 202 and magnetic strip 204 with user data.

Conventional methods and apparatus require a person to remove printed cards from a card printer and then apply elements one by one using applicator apparatus, for example place the cards in a chip applicator, remove them from the chip applicator and then place them in a hologram applicator, remove them from the hologram applicator and place them in a signature strip applicator, remove them from the signature strip applicator and place them in a magnetic strip encoder. Although the time and labour can be kept to a minimum when large batches of identical cards are printed, the time and labour requirements increase when personalised cards are required.

It is desirable when personalising transaction cards to provide several options of placement and/or appearance of elements such as elements 201 to 206. However personalisation of these elements at the production stage results in a lengthy and time-consuming production due to the various different production machines required as described above.

An object of the present invention is to reduce the time and labour requirements in printing a plurality of different personalised transaction cards.

### SUMMARY OF THE INVENTION

In a first aspect the invention provides a method of producing a plurality of transaction cards comprising the steps of:

providing a plurality of blank cards to which at least one element is to be applied, each card comprising at least one card tag, each card tag carrying production information identifying at least one element to be applied to the card and/or a location on the card at which at least one element is to be applied, wherein the production information carried by at least one of the plurality of card tags differs from the production information carried by at least another one of the plurality or card tags;

reading the card tag;

sorting the plurality of cards into at least first and second sorted groups based on the production information; and

applying the at least one element to the card.

Optionally, each card is provided with only one card tag.

Optionally, the production information comprises identification of a plurality of elements to be applied to the card and/or a plurality of locations at which a corresponding plurality of elements are to be applied.

Optionally, the element is selected from a magnetic strip, a signature strip, a hologram and a computer chip.

Optionally, the method comprises the step of applying an image to at least one card layer before application of the at least one element.

Optionally, the image applied to one of a plurality of card layers is different from the image applied to at least one other of the plurality of card layers.

Optionally, the image is printed onto a front or back card layer prior to collation with the other of the front and back card layer.

Optionally, the card layer is provided in a sheet of card layers.

Optionally, front and back card layer sheets are collated to form a sheet of blank cards.

Optionally, the sheet of blank cards comprises a sheet tag on the front card layer and a sheet tag on the back card layer.

Optionally, the front and back sheet tags identify an image to be applied to the respective front and back of each card.

Optionally, each card carries a unique identification number.

Optionally, the method comprises the steps of reading the unique identification number; matching the number to a user account; and applying the user's details to the card.

Optionally, the user's details are maintained in a secure database.

Optionally, the card tag is computer readable, preferably a barcode.

Optionally, the sheet tag is computer readable, preferably a barcode.

In a second aspect the invention provides a card sorting machine for sorting a plurality of blank cards, each card comprising at least one card tag readable by the card sorting machine, each card tag identifying at least one element to be applied to the card and/or the location in which a element is to be applied, wherein the card sorting machine is configured to sort the plurality of cards into at least two sorted groups according to the at least one element.

In a third aspect the invention provides a method of producing a plurality of cards comprising the steps of:

providing a plurality of front sheets, each front sheet comprising a plurality of card front layers and a front tag;

providing a plurality of back sheets, each back sheet comprising a plurality of card back layers and a back tag;

applying to each card front layer an image identified by the front tag;

applying to each card back layer an image identified by the back tag;

identifying matching front and back tags; and

collating front and back sheets comprising matching front and back tags to form a sheet of cards.

By “blank card” as used herein is meant a card to which one or more elements are to be applied. The blank card may carry one or more elements or images before being subjected to the method of the present invention, however in one embodiment the blank card does not carry any elements or images before going through the inventive method.

By “element” is meant a card component that is attached to the surface of the card, for example by lamination or adhesion. Exemplary elements of a card include a computer chip, a hologram, a signature strip and a magnetic stripe.

It will be appreciated that the plurality of card tags on the plurality of blank cards between them identify at least two different elements or two different locations of elements in order that the method of the invention results in the production of at least two different transaction cards.

### DESCRIPTION OF THE DRAWINGS

The invention will now be described in detail with reference to the drawings wherein:

FIG. 1 shows the layer structure of a typical transaction card

FIGS. 2A and 2B shows elements to be applied to a card

FIG. 3 shows an interface for designing a card

FIG. 4 shows a flowchart for selecting elements and element types to be visible in an interface

FIG. 5 shows a flowchart for creating a new stock card product

FIG. 6 illustrates communication of a card between a card designer, a card issuer and a card manufacturer

FIG. 7 is a flowchart showing the process for manufacturing a card according to the present invention

FIG. 8 illustrates a sheet of outer card layers

FIG. 9 illustrates a card sheet carrying a plurality of cards

FIGS. 10a, 10b and 10c illustrate screen shots of an interface for designing a card

### DETAILED DESCRIPTION OF THE INVENTION

In a first step, a card designer and/or customer generates a card design to be applied to a personalised card by selecting elements and/or the location of those elements on the front and/or back of the card, and submits an order for the personalised card. An image to be applied to the card may also be selected.

This order is communicated to a card producer, where a plurality of different cards are manufactured, such that card elements that are common to two or more of the different cards may be identified and applied in a batch process, as described in more detail below.

Finally, in the case of a card carrying confidential data, such as a credit or debit card, this data is applied to the card and the card is issued to the user.

### Generating and Ordering a Card Design

A design to be applied to a card may be generated and ordered using a system that enables a user to select elements to be applied to the front and/or back of the card.

This may be advantageously done via a card ordering website using an application such as an online card design service, in which the user may select the elements and the location thereof from a menu associated with each element or other interface allowing the user to generate an image of the desired card. The user may at this stage also select an image to be applied to the front and/or rear of the card. This image may be selected from an existing database of images stored on a server or may be an image uploaded to the server by the user. The image may be manipulated, in particular resized or cropped using the aforementioned application, in order to fit the card. More detail of image manipulation is provide in WO 2006/018624, incorporated herein in its entirety.

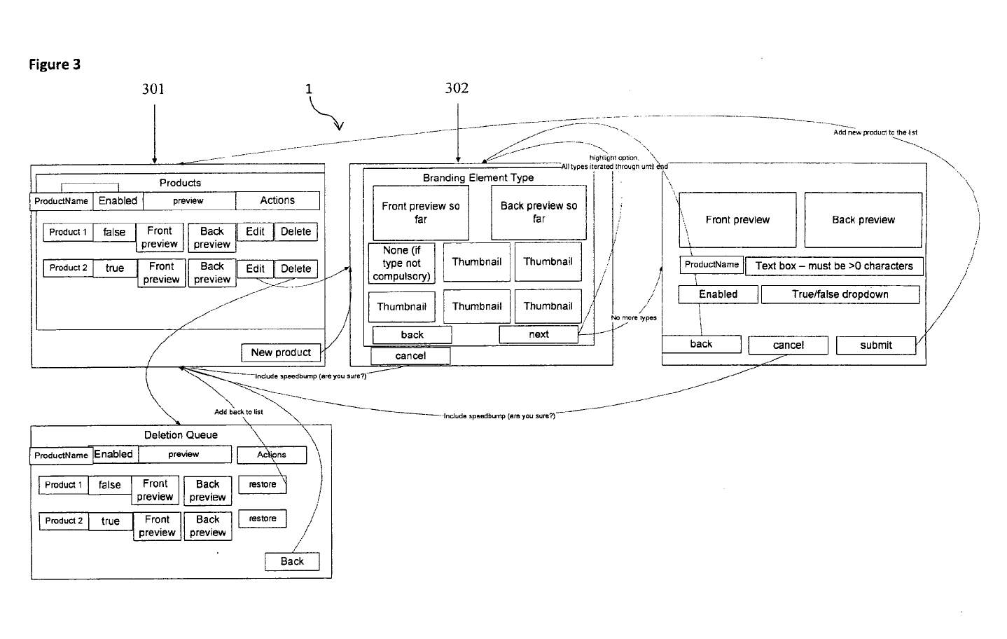

A user interface is illustrated in FIG. 3, which shows a wizard that guides the customer in sequence through the various elements that may be applied to the card. At a first page 301 the customer defines a product name for their chosen product that serves to identify the card design created by the customer. A unique product number will also be generated at this stage that will remain the same, regardless of whether the product name is later changed by the user. Existing products may be viewed, selected for editing or deleted at this first page.

At the next page 302 the user may select the element of a first element type (e.g. signature strip, hologram, computer chip, etc.) to be applied to the card, or may select to apply no element if that element type is not compulsory for the card in question. For each element type, there may be one or more elements that the user can select from (for example, a choice of different holograms). The user may also select the location of that element. This is repeated for the element of a second element type, a third element type, and so on for each element type to be applied to the card. At each stage, a preview of the front and back of the card so far may be provided. Elements may be represented as an image, such as a file in PNG format.

The choice of element types and/or elements available to a customer as illustrated in FIG. 3 may be set by a card issuer, in particular to allow the customer to only select those elements that the printing bureau is capable of applying to the card and, if necessary, to make the choice of certain elements and/or element types compulsory for legal or other reasons.

In a first administrative step, all the options available in the card design based on the hardware and production setup and the printing bureau are set using an administration interface.

The second step is to then create the fixed branding elements for a new card programme. This is done by the card issuer (or another party). The third step is to then allow a designer to create ideas for the card look, both front and back, which lies behind the fixed branding elements. Finally the fourth step allows the assignment of a specific front design to a specific back design. This becomes a ‘stock’ card design.

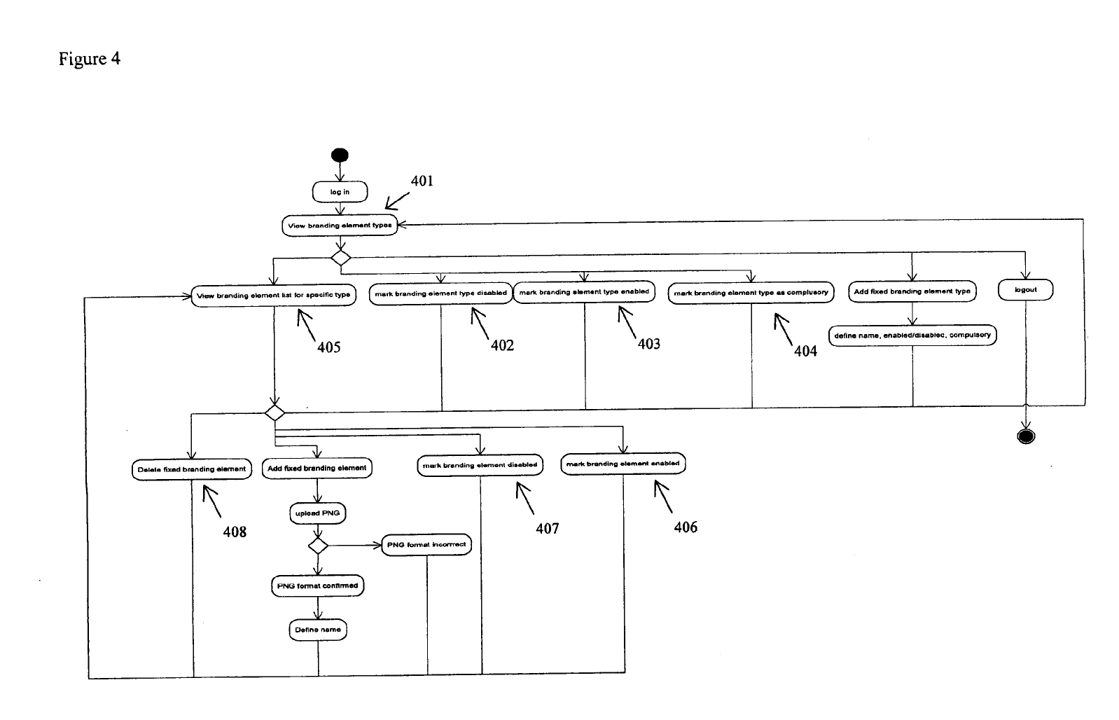

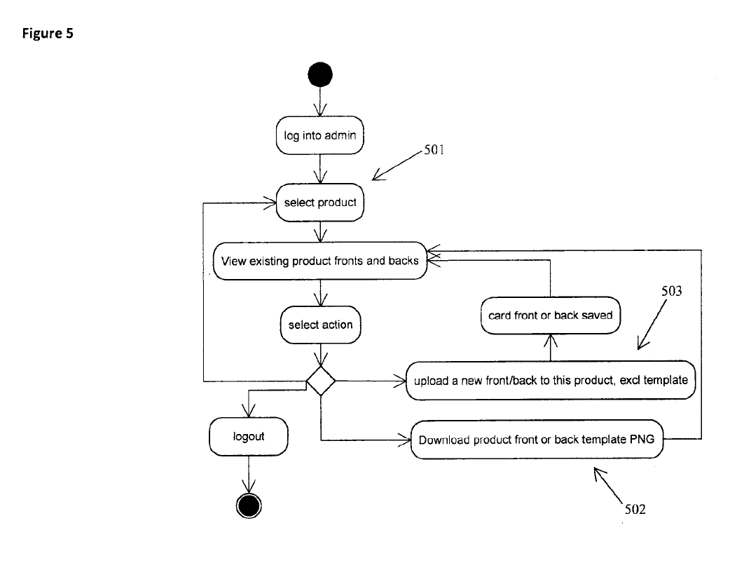

FIG. 4 illustrates a process by which an administrator sets the options available to a customer. Each branding element type is set at 401 by the administrator to be disabled (i.e. not available to the customer) 402, enabled (i.e. available for the customer to select if he or she wishes) 403 or compulsory 404. The one or more elements available for each element type may likewise be selected at 405 to be enabled 406, disabled 407 or fixed 408. An element may also be deleted (408).

In addition to generating “one-off” cards, the system also allows for creation, storage and editing of a “stock” card, that is a card design to be applied to a plurality of cards. The stock card design may provide for a fixed identity and location of all of the elements to be applied to a card, or it may define the identity and location of only one or more elements such that a user may further modify the stock card.

FIG. 5 illustrates the process for creating a new stock card. An existing product template is selected (501) and downloaded in PNG format (502). The template may then be edited with a program such as Photoshop and uploaded (503) to create a new product.

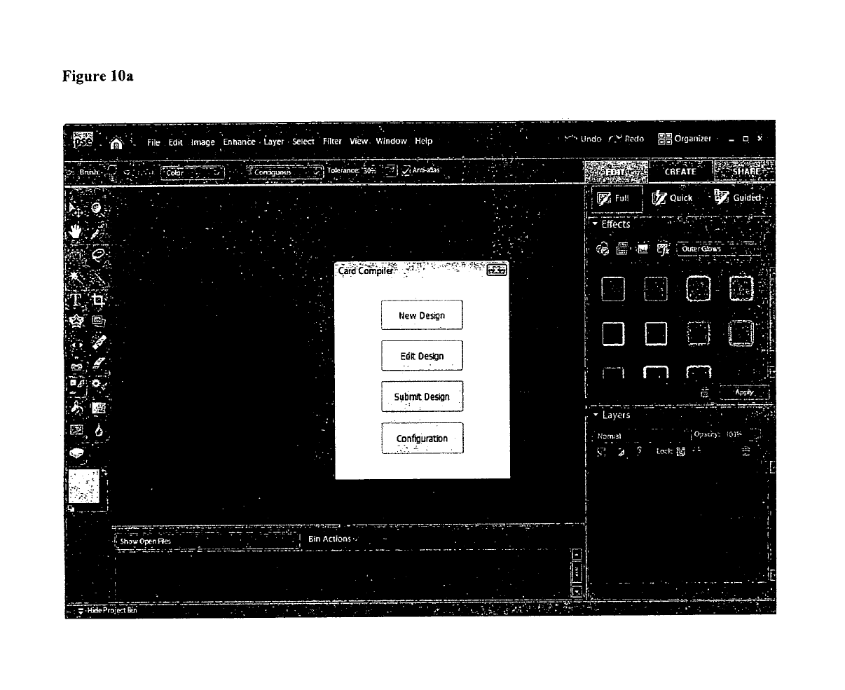

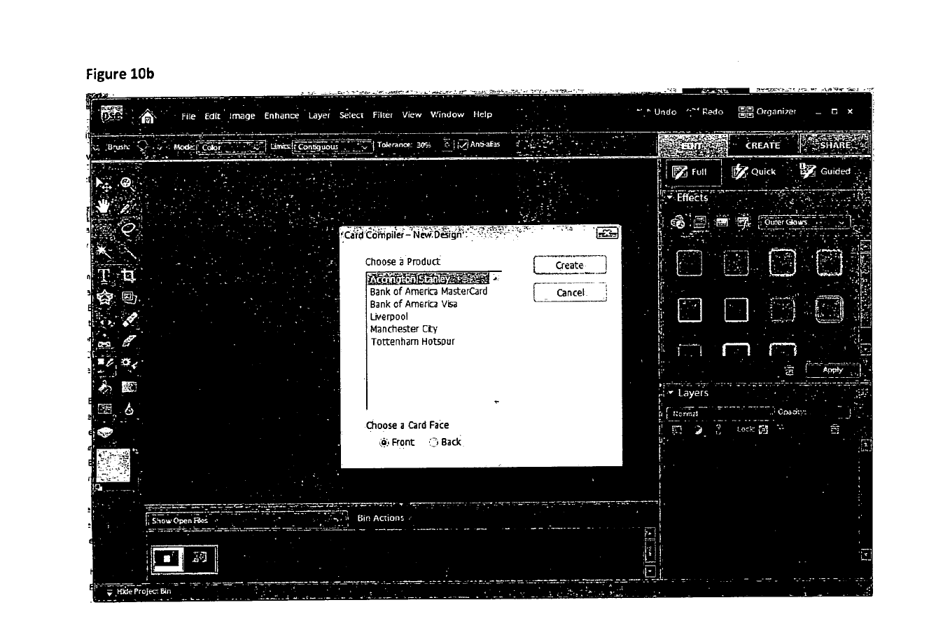

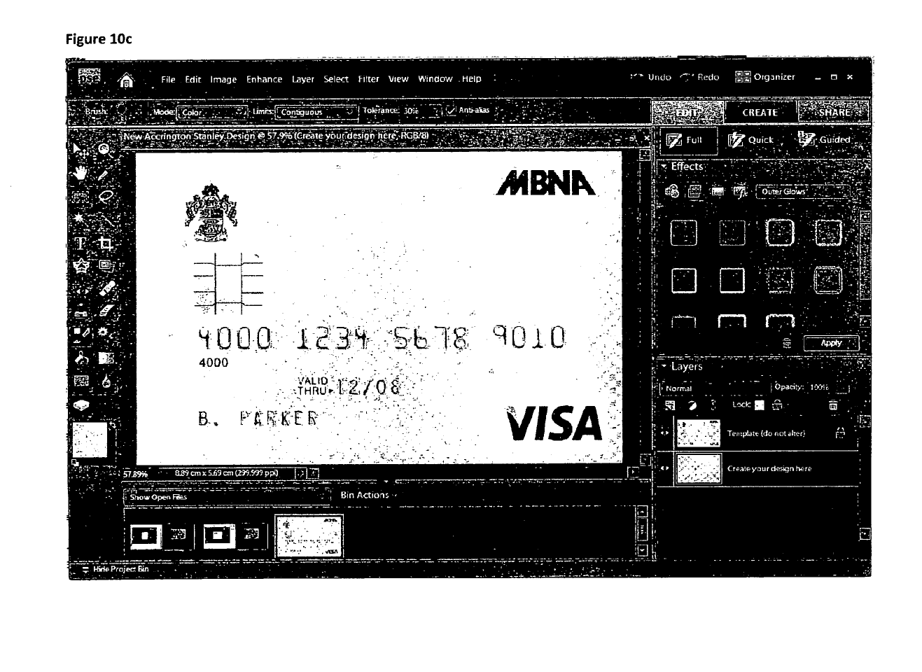

FIGS. 10a, b and c show the interface for a plug-in application which runs within Photoshop or other graphics packages. This allows the user to select from a list of templates (that are appropriate to the user—as designated by a username and password added to the configuration settings of the plug-in). The user can select front or back for the designated template. There are key flows of data from the webserver including the listings of the templates, the imagery (including transparent areas) of the templates, the names of the templates and metadata whether the template is the front or back of the card.

### Communication of Orders

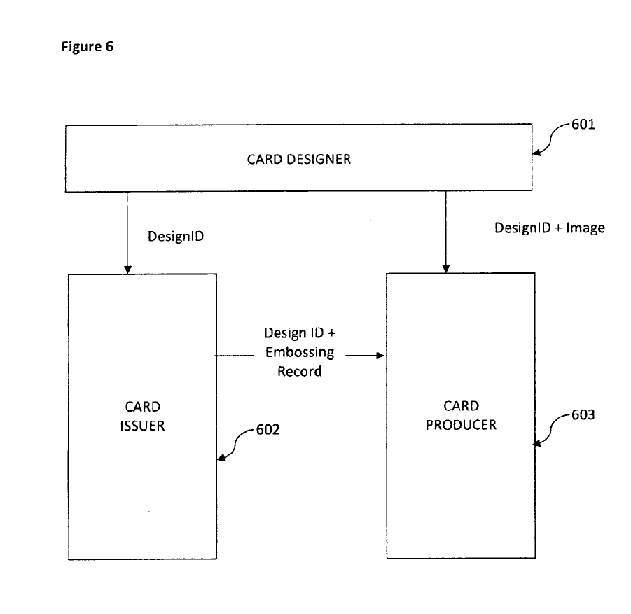

With reference to FIG. 6, a user such as a card designer or card customer 601 generates and orders a card design, for example through a PC connected to a website as described above. This order may comprise a completely new card design or a modification of an existing product, as described above.

In order to manufacture the card, the details of the images, elements and card layout have to be communicated to a card producer 603. Additionally, the customer's details also need to be communicated in order that these details may be associated with and applied to the personalised card, in particular by one or more of embossing and/or printing the customers details onto the card; and writing the customer's details onto a magnetic stripe and/or card chip. The customer's details may include confidential information such as the customer's name, account number and card security code, and so this information must be supplied and stored securely.

The completed card design is given a “Design ID” identifier that identifies the identity and layout of elements to be applied to the card. The Design ID also provides identification of the cardholder, in order that the cardholder may be related to their choice of card design. The identification of the cardholder can be based on the their name or other personal details or banking details, but the cardholder may be assigned a unique User ID number. The Design ID may also identify the user selected image, if any, to be applied to the card. This Design ID is associated with the cardholder's account by the card issuer 602, and the cardholder information required for embossing of the card and for application to the chip is included in an “embossing request” from the card issuer 602 to the card producer 603. The embossing request is transmitted securely to, and stored securely by, the card producer in a secure user data storage device.

More detailed in formation on secure technical means for providing information capable of associating user identity and/or account information with a customer's personalized card is disclosed in WO 2006/018624, incorporated herein in its entirety.

### Processing of Card Orders

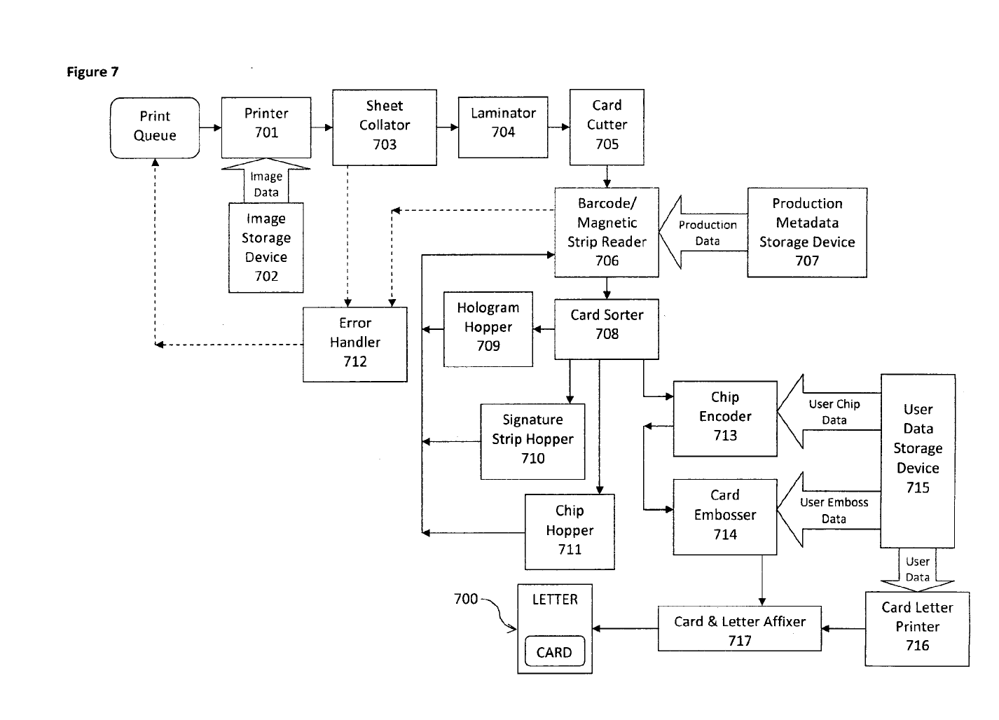

With reference to FIG. 7, a queue process translates a list of Design IDs into a card database, and a check is made on the server associated with the aforementioned website (or other ordering means) to ensure that there is a design corresponding to each Design ID. If a corresponding design is found, the card is assigned a unique serial number that is stored in a database and entered into a printing queue. A list is generated of any Design IDs that do not have a corresponding design, and this list is communicated back to the server in order to identify Design IDs that have not been taken forward for processing.

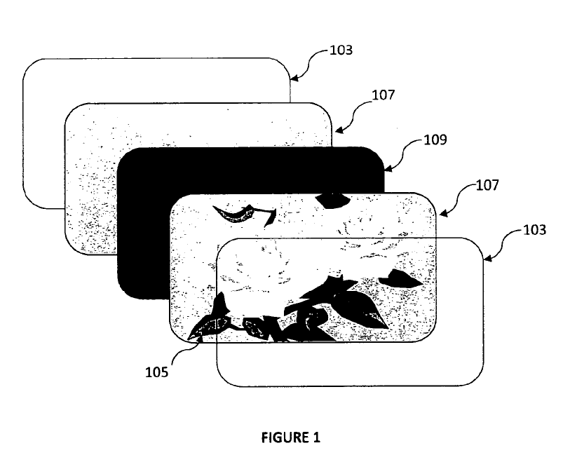

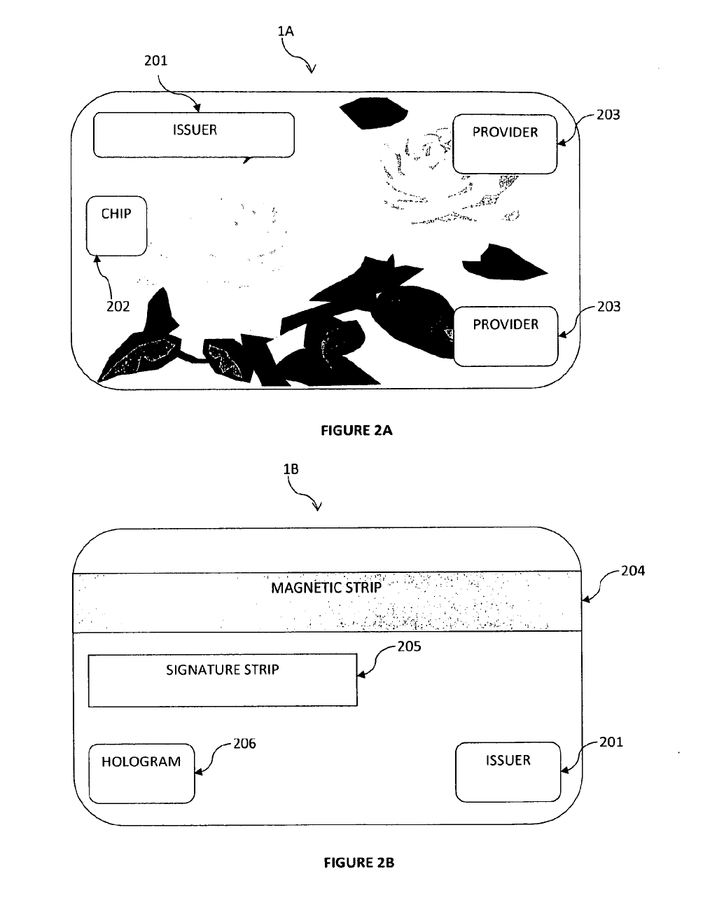

Images 105 may be printed onto outer card layers 107 illustrated in FIG. 1 to form front and back printed outer layers that then need to be collated. These outer card layers may be printed individually, however in one embodiment a sheet of front outer card layers and a sheet of back outer card layers are provided and printed, wherein the images printed onto the card layers on any given sheet may be the same or different.

These sheets then need to be collated, and in particular the images on the front and back sheets need to be matched up.

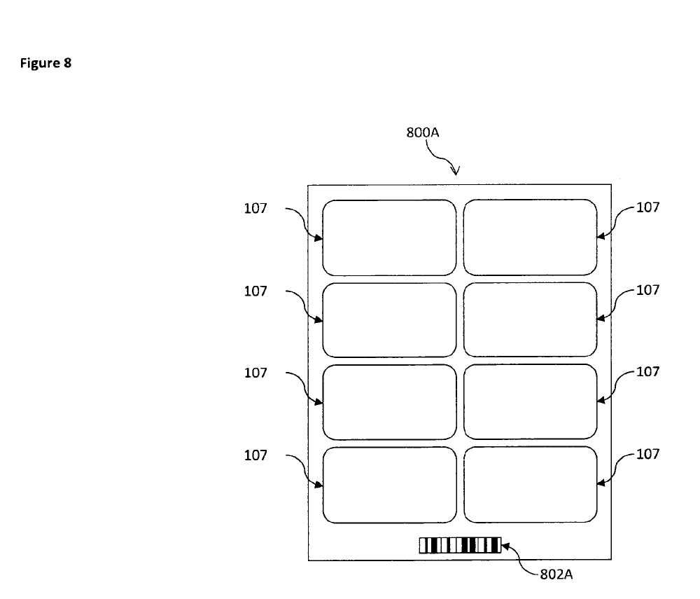

The sheets are illustrated in FIG. 8. Each sheet 800 carries a barcode 802. Matching front and back sheets either carry the same barcode or are otherwise related.

With reference to FIG. 7, an image is printed onto the front and/or back sheets in the print queue using printer 701 and using image data stored in image storage device 702, for example the server to which a customer uploaded an image to be applied to a card. A barcode is also printed onto the front or back sheet at this stage, based on the queue order and card serial number. Typically, at least one of the front or back layer will be printed onto although it will be appreciated that an image may not be printed onto some or all cards (for example, because the cards as provided already carry an image).

The sheets are collated by sheet collator 703 following appropriate collation based on the front and rear sheet barcodes.

Further layers, e.g. carrying association logos and potential issuer logos may also be collated at this stage. These physical layers can be modelled as virtual layers within a graphic design package to match the design process to the physical card production process.

A UV layer can be laid down (e.g. screen printed) on the printed image or on the inside of the laminate layer. Typically to make this possible the UV layer must be solvent based so that the UV layer need not be ‘cured’ with heat which would not be possible on thin laminate layers. Equally ‘gold’ and ‘platinum’ layers may be screen printed at this stage.

After collation, a barcode is applied to each card.

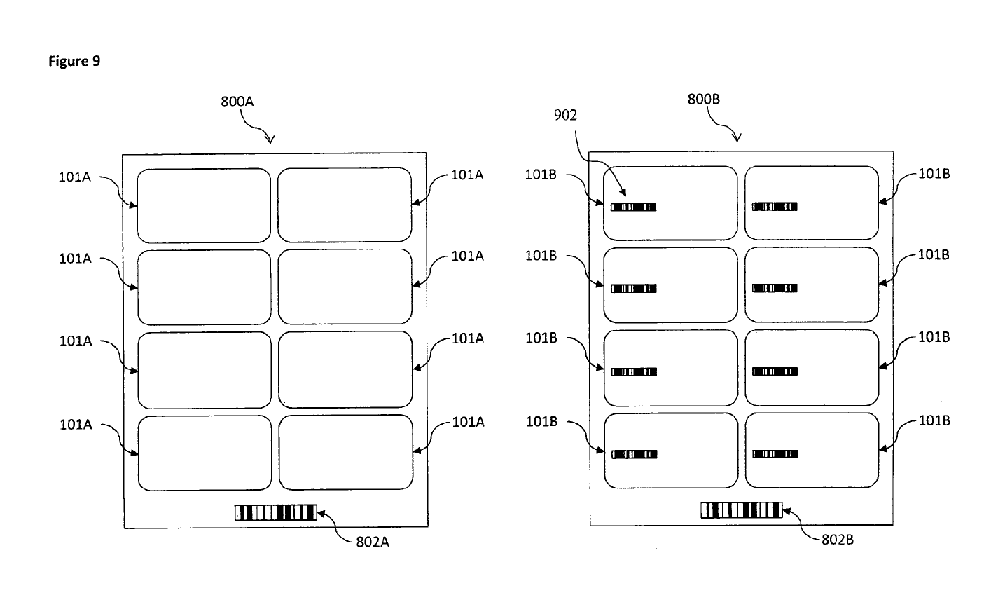

A sheet of cards formed following collation is illustrated in FIG. 9. Each card 101 comprises a barcode 902 on either its front surface 101A or back surface 101B, and as described above each sheet comprises a barcode 802A, 802B on its front surface 800A and back surface 800B respectively.

The barcode for each card carries the serial number that is unique to that card. The serial number can be used to identify the Design ID to be applied to that card (which may or may not be the same as one or more cards to be manufactured).

Use of barcodes on the sheets ensures correct collation order and correct matching of front and back sheets. Referring to FIG. 1, this ensures that layer 107 on the front of the card is matched to the correct layer 107 to be applied to the back of the card. The barcodes on the front and back of the sheets may be the same or may be related within the database. Either way it means that there need only be a barcode on one side of each card. Moreover, by providing barcodes on the sheets, any problems arising from an unreadable (e.g. damaged) barcode on a card can be overcome by scrapping the damaged card and sending an instruction to generate a replacement card using the production data for that card obtainable from one or both of the barcode sheets.

The order of the cards on the sheets is such that they are in an order which is suitable for the manufacturing process, as determined by rules about which cards can be on which sheets, and which order these cards should be in.

The collated sheets are then laminated by laminator 704 to seal the individual sheets. The sheets are then cut into individual cards by card cutter 705.

Once an individual card has been punched from a sheet, it is identifiable only via the barcode 803 printed on the front or back of the card. This card must then go through the reconciliation process. This is comprised of the steps of reading the serial number from the barcode on the card and checking the serial number against the database.

In one embodiment, the Design ID that corresponds to the serial number is encoded on the magnetic stripe. The magnetic stripe may then be read in order to associate the customer records with the card design choice in the embossing process. Particularly, the Design ID encoded on the magnetic stripe is the same identifier for the embossing record associated with the cardholder's personal data. Additionally, applications such as the error handling mechanism 712 can still identify the card as long as the barcode is kept visible (i.e. not covered by card elements) in order to allow reading of the serial number.

In an alternative embodiment, the serial number is encoded on the magnetic stripe instead of the Design ID. This allows the barcode to be covered by one of the elements to be applied to the card since the same information will then be available on the magnetic stripe instead.

Once the barcode has been scanned and the Design ID has been encoded onto the magnetic stripe of the card, the magnetic stripe may then be used to associate the customer records with the card design choice in the embossing process.

The card sorter 708 makes use of the unique serial number that can be read from the barcode on each card to allow an operator to separate a single stack of cards into multiple stacks depending on one or more properties. For example, the sorting machine may split a single stack of cards into one stack per hologram or hologram position, thereby allowing the operator to process each stack in series using a hologram hopper 709 to apply the hologram. For each stack the hopper contains the hologram identified by the serial number and is set to apply the hologram in the location identified by the serial number. The same process is then carried out for the signature strip and the chip using signature strip hopper 710 and chip hopper 711, and any other elements to be applied to the card.

In order to further increase the efficiency of the process, each stack could be arranged by more than one property, for example a stack in which the hologram and signature strip are the same and are to be applied in the same location. Such a stack may be fed into more than one hopper without having to sort the cards in the stack between hoppers.

The card is then supplied to a chip encoder 713 and card embosser 714 for encoding the chip and embossing the card with the user's account details based on user data from secure user data storage device 715. The device 715 determines the data to be applied to each card by reading the serial number on the barcode or the magnetic strip.

The completed card is then affixed to a letter generated from a card letter printer 716 and affixer 717 before being issued to the user in letter 700.

The data contained in data storage device 715 is securely stored, and the chip encoding and card embossing steps take place in a secure location. This location may be the same as the location in which one or more of the preceding steps in the card manufacture take place, however if these preceding steps take place in an unsecured location then the encoding and embossing steps may take place in a separate location.

In an alternative embodiment of the invention the data passed from the webserver to the card printing bureau may be divided in to two groups to allow the application of the data to the front and back of the card to occur at the point of personalisation using two different machines. In one embodiment these comprise the Datacard Artista (VHD) to lay down the imagery on the front of the card, and the Datacard Ultragraphics to lay down the imagery on the back of the card. In both instances the configuration of the imagery for front and back will be different for the different machines. The card in this case will typically carry one or more physical elements on the card (such as the magnetic stripe and holograms) and optionally some pre-printed logos.

Although the present invention has been described in terms of specific exemplary embodiments, it will be appreciated that various modifications, alterations and/or combinations of features disclosed herein will be apparent to those skilled in the art without departing from the scope of the invention as set forth in the following claims.

1. A method of producing a plurality of transaction cards comprising the steps of:
providing a plurality of blank cards to which at least one element is to be applied, each card comprising at least one card tag, each card tag carrying production information identifying at least one element to be applied to the card, wherein the production information carried by at least one of the plurality of card tags differs from the production information carried by at least another one of the plurality of card tags;
reading the card tag;
sorting the plurality of cards into at east first and second sorted groups based on the production information; and
applying the at least one element to the card.

2. A method according to claim 1 wherein each card is provided with only one card tag.

3. A method according to claim 1 wherein the production information comprises identification of a plurality of elements to be applied to the card.

4. A method according to claim 1 wherein the element is selected from a magnetic strip, a signature strip, a hologram and a computer chip.

5. A method according to claim 1 comprising the step of applying an image to at least one card layer before application of the at least one element.

6. A method according to claim 5 wherein the image applied to one of a plurality of card layers is different from the image applied to at least one other of the plurality of card layers.

7. A method according to claim 5 wherein the image is printed onto a front or back card layer prior to collation with the other of the front and back card layer.

8. A method according to claim 5 wherein the card layer is provided in a sheet of card layers.

9. A method according to claim 8 wherein front and back card layer sheets are collated to form a sheet of blank cards.

10. A method according to claim 9 wherein the sheet of blank cards comprises a sheet tag on the front card layer and a sheet tag on the back card layer.

11. A method according to claim 10 wherein the front and back sheet tags identify an image to be applied to the respective front and back of each card.

12. A method according to claim 1 wherein each card carries a unique identification number.

13. A method according to claim 12 comprising the steps of reading the unique identification number; matching the number to a user account; and applying the user's details to the card.

14. A method according to claim 13 wherein the user's details are maintained in a secure database.

15. A method according to claim 1 wherein the card tag is a computer readable barcode.

16. A method according to claim 1 wherein the sheet tag is a computer readable barcode.

17. A card sorting machine for sorting a plurality of blank cards, each card comprising at least one card tag readable by the card sorting machine, each card tag identifying at least one element to be applied to the card, wherein the card sorting machine is configured to sort the plurality of cards into at least two sorted groups according to the at least one element.

18. A method of producing a plurality of cards comprising the steps of:
providing a plurality of front sheets, each front sheet comprising a plurality of card front layers and a front tag;
providing a plurality of back sheets, each back sheet comprising a plurality of card back layers and a back tag;
applying to each card front layer an image identified by the front tag;
applying to each card back layer an image identified by the back tag;
identifying matching front and back tags; and
collating front and back sheets comprising matching front and back tags to form a sheet of cards.

19. (canceled)
